(19) United States
(12) Patent Application Publication
(10) Pub. No.: US 2026/0302944 A1
(43) Pub. Date: Oct. 1, 2026

(54) Control Circuit of Variable-Frequency Switching Converter and Variable-Frequency Switching Converter

(71) Applicant: SG MICRO CORP, Beijing (CN)

(72) Inventor: Jun YAN, Beijing (CN)

(73) Assignee: SG MICRO CORP, Beijing (CN)

(21) Appl. No.: 18/880,305

(22) PCT Filed: Jun. 26, 2024
(86) PCT No.: PCT/CN2024/101557

§ 371 Date: Dec. 31, 2024

(30) Foreign Application Priority Data
Aug. 8, 2023 (CN) 202310996004.9

(51) Int. Cl. H02M 3/156; H02M 1/088; H02M 3/157; H02M 3/158; H03K 7/08

(52) U.S. Cl. CPC H02M 3/1566; H02M 1/088; H02M 3/157; H02M 3/158; H03K 7/08

(57) ABSTRACT

A control circuit of a variable-frequency switching converter includes a duty ratio modulation signal generation module, a Constant On Time (COT) trigger signal generation module, and a control module, wherein the duty ratio modulation signal generation module outputs a duty ratio modulation signal to a first end of the control module; the COT trigger signal generation module outputs a COT trigger signal to a second end of the control module when a ripple voltage is less than a ripple reference voltage; and the control module generates a fixed on frequency pulse width signal based on the duty ratio modulation signal and a clock signal when the COT trigger signal is not received, outputs a control signal based on the fixed on frequency pulse width signal, and generates a COT pulse width signal based on the control signal and the COT trigger signal when the COT trigger signal is received.

### CROSS-REFERENCE TO THE RELATED APPLICATIONS

This application is the national phase entry of International Application No. PCT/CN2024/101557, filed on Jun. 26, 2024, which is based upon and claims priority to Chinese Patent Application No. 202310996004.9, filed on Aug. 8, 2023, the entire contents of which are incorporated herein by reference.

### TECHNICAL FIELD

The present disclosure relates to the technical field of integrated circuits, and in particular, to a control circuit of a variable-frequency switching converter and the variable-frequency switching converter.

### BACKGROUND

Nowadays, the upgrading of consumer, communication, Internet of Things, and automotive electronic products is accelerating, the performance requirements are becoming more stringent, and the functions are becoming more complex, which puts higher and higher requirements for the dynamic performance of switching converters. As the world enters the era of big data, with the national project of “East Data, West Computing” underway, and AI technology advancing by leaps and bounds, the demand for servers and data centers is becoming more urgent. Many servers require rapid changes in current of loads such as Field Programmable Gate Arrays (FPGAs), Application-Specific Integrated Circuits (ASICs), and other high-power Central Processing Units (CPUs). In addition, in order to ensure the data security and the safety and reliability of server systems, server power systems often have more stringent transient response requirements.

A fixed-frequency circuit has a constant period, a narrower noise spectrum, a simpler filter circuit, and a smaller output voltage ripple, which is conducive to multi-phase parallel and stable phase control, while a variable-frequency circuit has a faster transient response speed and smaller output voltage changes when facing the same changing load. Therefore, there is an urgent need for a power supply circuit that operates at a constant frequency under stable load conditions, and when the load changes, the power supply circuit switches to a variable-frequency power supply circuit to quickly respond to the load change.

### SUMMARY

Embodiments described in the present disclosure provide a control circuit of a variable-frequency switching converter and the variable-frequency switching converter.

According to a first aspect of the present disclosure, a control circuit of a variable-frequency switching converter is provided, including a duty ratio modulation signal generation module, a Constant On Time (COT) trigger signal generation module, and a control module.

The duty ratio modulation signal generation module is configured to output a duty ratio modulation signal to a first end of the control module.

The COT trigger signal generation module is configured to output a COT trigger signal to a second end of the control module when a ripple voltage is less than a ripple reference voltage.

The control module is configured to generate a fixed on frequency pulse width signal based on the duty ratio modulation signal and a clock signal when the COT trigger signal is not received, generate a control signal based on the fixed on frequency pulse width signal, generate a COT pulse width signal based on the control signal and the COT trigger signal when the COT trigger signal is received, and generate a target pulse width signal based on the fixed on frequency pulse width signal and the COT pulse width signal.

The ripple voltage is generated based on a ripple voltage generation circuit, the ripple voltage generation circuit is configured to generate a first ripple voltage, and superpose a feedback voltage on an output voltage feedback node and the first ripple voltage to generate the ripple voltage, and the first ripple voltage is related to the target pulse width signal output by the control module.

In some embodiments of the present disclosure, the control module includes a first control unit, a second control unit, a time expansion unit, and a logic OR gate unit.

The first control unit is configured to generate the fixed on frequency pulse width signal based on the duty ratio modulation signal and the clock signal, and output the fixed on frequency pulse width signal to the time expansion unit and the logic OR gate unit respectively.

The time expansion unit is configured to output a first control signal to the second control unit based on the received fixed on frequency pulse width signal when the fixed on frequency pulse width signal is within a first preset time period, and output a second control signal to the second control unit when the fixed on frequency pulse width signal is within a second preset time period, where the first preset time period includes a time period when the fixed on frequency pulse width signal is a high level signal plus a minimum off time of at least one COT pulse width signal. The second preset time period includes a time period when the fixed on frequency pulse width signal is a low level signal minus the minimum off time of the at least one COT pulse width signal.

The second control unit is configured to output the COT pulse width signal to the logic OR gate unit based on the COT trigger signal when the second control signal and the COT trigger signal are received.

The logic OR gate unit is configured to generate a target pulse signal based on the fixed on frequency pulse width signal and the COT pulse width signal.

In some embodiments of the present disclosure, when the second control unit receives the first control signal output by the time expansion unit and does not receive the COT trigger signal output by the COT trigger signal generation module, the second control unit does not output the COT pulse width signal to the logic OR gate unit, the first control unit generates the fixed on frequency pulse width signal based on the duty ratio modulation signal and the clock signal, and sends the generated fixed on frequency pulse width signal to the logic OR gate unit, and the logic OR gate unit outputs the target pulse width signal based on the fixed on frequency pulse width signal.

When the second control unit receives the second control signal output by the time expansion unit and the COT trigger signal output by the COT trigger signal generation module, the second control unit outputs the COT pulse width signal to the logic OR gate unit, the logic OR gate unit outputs the fixed on frequency pulse width signal when the fixed on frequency pulse width signal is at a high level, and the logic OR gate unit outputs the COT pulse width signal when the fixed on frequency pulse width signal is at a low level.

In some embodiments of the present disclosure, a first end of the first control unit is electrically connected to an oscillator module, a second end of the first control unit is electrically connected to the duty ratio modulation signal generation module, a third end of the first control unit is electrically connected to a first end of the time expansion unit and a first end of the logic OR gate unit respectively, a second end of the time expansion unit is electrically connected to a first end of the second control unit, a second end of the second control unit is electrically connected to the COT trigger signal generation module, and a third end of the second control unit is electrically connected to a second end of the logic OR gate.

In some embodiments of the present disclosure, the first control unit at least includes a first latch and a minimum on/off time control unit. A first input end of the first latch is electrically connected to the oscillator module, a second input end of the first latch is electrically connected to the duty ratio modulation signal generation module, an output end of the first latch is electrically connected to a first end of the minimum on/off time control unit, and a second end of the minimum on/off time control unit is electrically connected to the first end of the time expansion unit and the first end of the logic OR gate unit respectively.

The second control unit at least includes an AND gate, a second latch, a timer, and a minimum off time control unit. A first input end of the AND gate is electrically connected to the second end of the time expansion unit, a second input end of the AND gate is electrically connected to the COT trigger signal generation module, an output end of the AND gate is electrically connected to an input end of the second latch, an output end of the second latch is electrically connected to an input end of the timer, an output end of the timer is electrically connected to a first end of the minimum off time control unit, a second end of the minimum off time control unit is electrically connected to a second end of the logic OR gate unit, and a third end of the minimum off time control unit is electrically connected to a third input end of the AND gate.

In some embodiments of the present disclosure, the duty ratio modulation signal generation module at least includes an error amplifier and a first comparator, and COT trigger signal generation module at least includes a ripple voltage generation circuit, a ripple reference voltage generation circuit, and a second comparator.

The error amplifier receives a direct current output feedback voltage of a main power module, and outputs an error voltage to the first comparator according to the direct current output feedback voltage and a reference voltage.

The first comparator outputs the duty ratio modulation signal according to the error voltage and the reference voltage, where the duty ratio modulation signal generation module, the COT trigger signal generation module, the control module, and the main power module form a loop, and the reference voltage is generated by collecting information of the loop in real time.

The second comparator receives the ripple voltage output by the ripple voltage generation circuit and the ripple reference voltage output by the ripple reference voltage generation circuit, and outputs the COT trigger signal according to the ripple voltage and the ripple reference voltage.

In some embodiments of the present disclosure, the COT trigger signal generation module and the duty ratio modulation signal generation module multiplex the same comparator.

A first input end of the comparator is electrically connected to an output end of the error amplifier, a second input end of the comparator is electrically connected to a reference voltage node, a third input end of the comparator is electrically connected to the ripple voltage generation circuit, a fourth input end of the comparator is electrically connected to the ripple reference voltage generation circuit, a first output end of the comparator is electrically connected to the first end of the control module, and a second output end of the comparator is electrically connected to the second end of the control module.

The comparator outputs the duty ratio modulation signal according to the error voltage and the reference voltage, and outputs the COT trigger signal according to the ripple voltage and the ripple reference voltage.

In some embodiments of the present disclosure, the ripple voltage generation circuit includes a first resistor, a first capacitor, a direct current offset extraction circuit, a first adder, an amplifier, a first buffer, and a second adder.

A first end of the first resistor is electrically connected to a switch node, a second end of the first resistor is electrically connected to a first end of the first adder, a first end of the direct current offset extraction circuit, and a first end of the first capacitor respectively, a second end of the direct current offset extraction circuit is electrically connected to a second end of the first adder, a third end of the first adder is electrically connected to a first end of the amplifier, a second end of the amplifier is electrically connected to a first end of the second adder, a first end of the first buffer is electrically connected to the output voltage feedback node, a second end of the first buffer is electrically connected to a second end of the second adder, an output end of the second adder is electrically connected to a ripple voltage generation node, and a second end of the first capacitor is electrically connected to a ground node.

In some embodiments of the present disclosure, the first resistor and the first capacitor filter a sampling voltage corresponding to the switch node to obtain a filtered sampling voltage and then output the filtered sampling voltage to the direct current offset extraction circuit, the direct current offset extraction circuit extracts a direct current signal in the filtered sampling voltage of the switch node, the first adder removes the direct current signal in the filtered sampling voltage of the switch node, and outputs an alternating current signal in the filtered sampling voltage of the switch node to the amplifier, and the amplifier amplifies the alternating current signal in the filtered sampling voltage of the switch node to obtain an amplified alternating current signal and then adds the amplified alternating current signal to the direct current output voltage of the output voltage feedback node through the second adder to obtain the ripple voltage.

In some embodiments of the present disclosure, the ripple voltage generation circuit includes a second buffer, a second resistor, a second capacitor, a first transconductance amplifier, a second transconductance amplifier, a switch, a third capacitor, and a third transconductance amplifier.

A first end of the second buffer is electrically connected to the output voltage feedback node, a second end of the second buffer is electrically connected to a first end of the second resistor, a second end of the second resistor is electrically connected to a first end of the first transconductance amplifier and a first end of the second capacitor respectively, a second end of the second capacitor is electrically connected to the ground node, a second end of the first transconductance amplifier is electrically connected to a first reference voltage node, a third end of the first transconductance amplifier and a fourth end of the third transconductance amplifier are electrically connected to the ripple voltage generation node, a fourth end of the first transconductance amplifier is electrically connected to a power supply voltage node, a first end of the second transconductance amplifier is electrically connected to a second reference voltage node, a second end of the second transconductance amplifier is electrically connected to the ground node, a third end of the second transconductance amplifier is electrically connected to a first end of the third capacitor, a first end of the switch, and a first end of the third transconductance amplifier respectively, a fourth end of the second transconductance amplifier is electrically connected to the power supply voltage node, a second end of the third transconductance amplifier and a third end of the third transconductance amplifier are connected to the ground node, a second end and a third end of the switch are electrically connected to the ground node, a control end of the switch is electrically connected to a pulse width signal output node, and a second end of the third capacitor is electrically connected to the ground node.

In some embodiments of the present disclosure, the second resistor and the second capacitor filter a sampling voltage corresponding to the output voltage feedback node to obtain a filtered sampling voltage and then output the filtered sampling voltage to the first transconductance amplifier, and the first transconductance amplifier generates a ripple direct current voltage. When the switch is in an off state based on a pulse width signal output by the pulse width signal output node, a current output by the third end of the second transconductance amplifier charges the third capacitor, and when the switch is in an on state based on the pulse width signal output by the pulse width signal output node, the third capacitor discharges, a triangular wave is formed based on the charging and discharging of the third capacitor and input to the third transconductance amplifier, a ripple current is generated based on the third transconductance amplifier, and a ripple voltage is generated based on a voltage generated by the ripple current and the ripple direct current voltage.

In some embodiments of the present disclosure, the ripple reference voltage generation circuit includes a fourth transconductance amplifier and a fifth transconductance amplifier.

A first end of the fourth transconductance amplifier is electrically connected to a reference voltage node of an output feedback voltage, a second end of the fourth transconductance amplifier is electrically connected to the first reference voltage node, a third end of the fourth transconductance amplifier and a third end of the fifth transconductance amplifier are electrically connected to a ripple reference voltage node, a first end of the fifth transconductance amplifier is electrically connected to a loop voltage node, a second end of the fifth transconductance amplifier is electrically connected to the ground node, and a fourth end of the fourth transconductance amplifier and a fourth end of the fifth transconductance amplifier are electrically connected to the power supply voltage node respectively.

According to a second aspect of the present disclosure, a variable-frequency switching converter is provided, including the control circuit of the variable-frequency switching converter in any one of the first aspect.

### BRIEF DESCRIPTION OF THE DRAWINGS

In order to more clearly illustrate the present disclosure or the technical solutions in the related art, the drawings used in the description of the embodiments or the related art will be briefly described below. It is apparent that the drawings described below are only some embodiments of the present disclosure and not intended to limit the present disclosure. Other drawings may further be obtained by those of ordinary skill in the art according to these drawings without creative efforts.

FIG. 1 is a schematic structural diagram of a control circuit of a switching converter according to an embodiment of the present disclosure.

FIG. 2 is a schematic diagram of a circuit structure of a control module according to an embodiment of the present disclosure.

FIG. 3 is a schematic structural diagram of another control circuit of a switching converter according to an embodiment of the present disclosure.

FIG. 4 is a schematic structural diagram of a ripple voltage generation circuit according to an embodiment of the present disclosure.

FIG. 5 is a schematic structural diagram of another voltage generation circuit according to an embodiment of the present disclosure.

FIG. 6 is a schematic structural diagram of a ripple reference voltage generation circuit according to an embodiment of the present disclosure.

FIG. 7 is an operation time sequence diagram according to an embodiment of the present disclosure.

FIG. 8 is an operation time sequence diagram of a control circuit of a switching converter according to an embodiment of the present disclosure.

FIG. 9 is a schematic diagram of simulation results of an output voltage of a switching converter with a variable-frequency transient enhancement circuit added and the output voltage of the switching converter without the variable-frequency transient enhancement circuit added according to an embodiment of the present disclosure.

In the drawings, reference signs with the same last two digits correspond to the same elements. It is to be noted that the elements in the drawings are schematic and not drawn to scale.

### DETAILED DESCRIPTION OF THE EMBODIMENTS

In order to make the purpose, technical solutions, and advantages of embodiments of the present disclosure clearer, the technical solutions in the embodiments of the present disclosure will be described clearly and completely below with reference to the drawings. It is apparent that the described embodiments are part rather than all embodiments of the present disclosure. On the basis of the description of the embodiments of the present disclosure, all other embodiments obtained by those skilled in the art without creative work shall fall within the scope of protection of the present disclosure.

Unless otherwise defined, all terms used herein (including technical and scientific terms) have the same meanings as those commonly understood by those skilled in the art that the subject of the present disclosure belongs. Further, it is to be understood that terms such as those defined in commonly used dictionaries should be interpreted as having the meanings consistent with those in the context of the specification and related technologies, and will not be interpreted in an idealized or overly formal form, unless otherwise defined herein. As used herein, the statement that two or more parts are “connected” or “coupled” together shall mean that these parts are combined directly or through one or more intermediate parts.

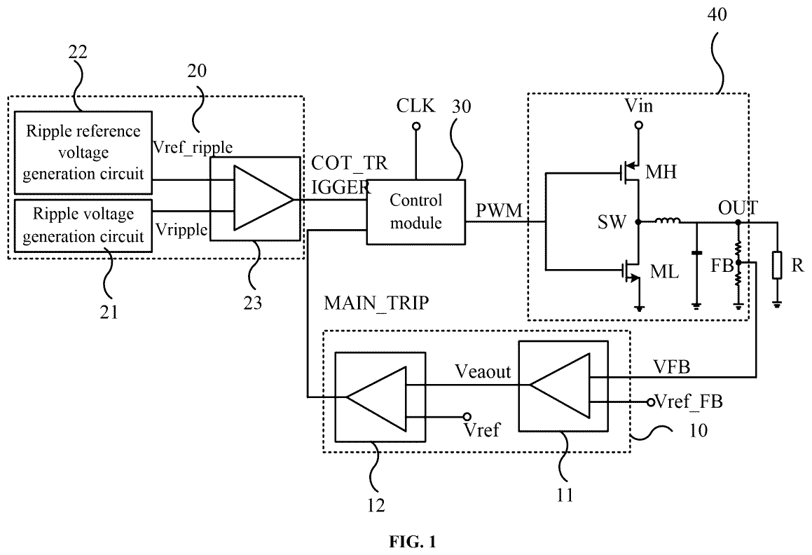

Based on the problems existing in the related art, the embodiments of the present disclosure provide a control circuit of a variable-frequency switching converter. As shown in FIG. 1, the control circuit of the switching converter includes a duty ratio modulation signal generation module 10, a COT trigger signal generation module 20, and a control module 30. The duty ratio modulation signal generation module 10 is configured to output a duty ratio modulation signal to a first end of the control module 30. The COT trigger signal generation module 20 is configured to output a COT trigger signal to a second end of the control module 30 when a ripple voltage is less than a ripple reference voltage. The control module 30 is configured to generate a fixed on frequency pulse width signal based on the duty ratio modulation signal and a clock signal when the COT trigger signal is not received, generate a control signal based on the fixed on frequency pulse width signal, generate a COT pulse width signal based on the control signal and the COT trigger signal when the COT trigger signal is received, and generate a target pulse width signal based on the fixed on frequency pulse width signal and the COT pulse width signal. The ripple voltage is generated based on a ripple voltage generation circuit, the ripple voltage generation circuit is configured to generate a first ripple voltage, and superpose a feedback voltage on an output voltage feedback node and the first ripple voltage to generate the ripple voltage, and the first ripple voltage is related to the target pulse width signal output by the control module.

In a specific implementation, a load R of a power system is electrically connected to a direct current output voltage node OUT of a main power module 40. When the power system operates normally, in the COT trigger signal generation module 20, the ripple voltage generation circuit collects an operating state of the main power module 40 (including an upper power transistor and a lower power transistor), and generates the ripple voltage Vripple based on the collected operating state of the main power module 40 (including the upper power transistor and the lower power transistor). When the ripple voltage Vripple is higher than the ripple reference voltage Vref_ripple, the COT trigger signal generation module 20 does not generate the COT trigger signal COT_TRIGGER that is, the control module 30 does not receive the COT trigger signal COT_TRIGGER At this time, the control module 30 generates the fixed on frequency pulse width signal based on the received duty ratio modulation signal MAIN_TRIP and the clock signal CLK, and generates the control signal corresponding to the fixed on frequency pulse width signal. At this time, the main power module 40 operates in a fixed on frequency mode. When the load R corresponding to the power system increases and causes the output voltage of the main power module 40 to drop (that is, the output voltage of the output voltage feedback node FB drops), at this time, the ripple voltage Vripple generated by the ripple voltage generation circuit 21 based on the collected operating state of the main power module is lower than the ripple reference voltage Vref_ripple. At this time, the COT trigger signal generation module 20 generates the COT trigger signal COT_TRIGGER, that is, the control module 30 receives the COT trigger signal COT_TRIGGER, and the control module 30 first generates the fixed on frequency pulse width signal based on the received duty ratio modulation signal MAIN_TRIP and the clock signal CLK, generates the control signal based on a fixed frequency pulse signal, and then generates the COT pulse width signal based on the control signal and the COT trigger signal COT_TRIGGER. At this time, the main power module 40 operates alternately in the fixed on frequency mode and a COT mode.

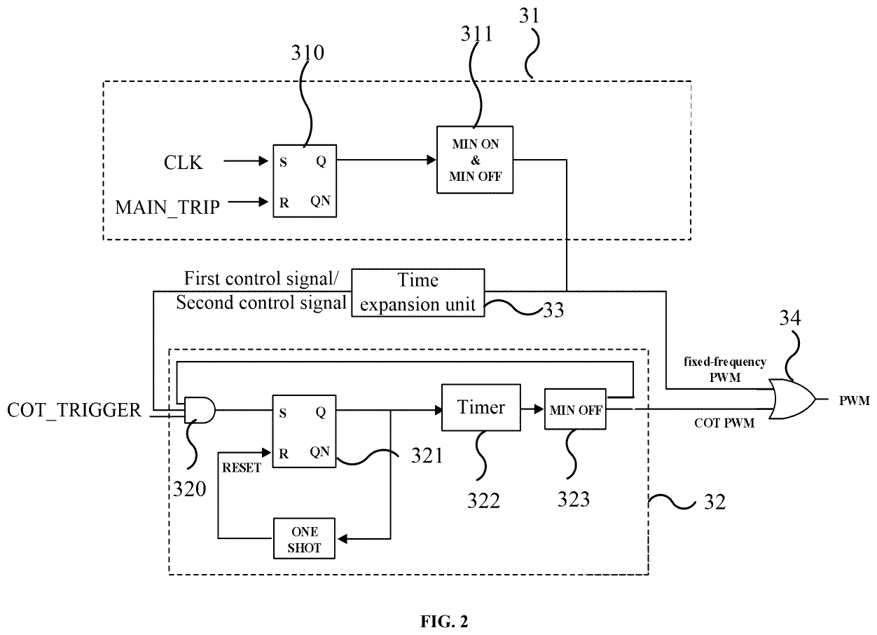

As a specific implementation, as shown in FIG. 2, the control module 30 includes a first control unit 31, a second control unit 32, a time expansion unit 33, and a logic OR gate unit 34. A first end of the first control unit 31 is electrically connected to an oscillator module (not shown in the figure), a second end of the first control unit 31 is electrically connected to the duty ratio modulation signal generation module 10, a third end of the first control unit 31 is electrically connected to a first end of the time expansion unit 33 and a first end of the logic OR gate unit 34 respectively, a second end of the time expansion unit 33 is electrically connected to a first end of the second control unit 32, a second end of the second control unit 32 is electrically connected to the COT trigger signal generation module 20, and a third end of the second control unit 32 is electrically connected to a second end of the logic OR gate 34.

The first control unit 31 at least includes a first latch 310 and a minimum on/off time control unit 311. A first input end S of the first latch 310 is electrically connected to the oscillator module, a second input end R of the first latch 310 is electrically connected to the duty ratio modulation signal generation module 10, an output end of the first latch 310 is electrically connected to a first end of the minimum on/off time control unit 311, and a second end of the minimum on/off time control unit 311 is electrically connected to the first end of the time expansion unit 33 and the first end of the logic OR gate unit 34 respectively.

The second control unit 32 at least includes an AND gate 320, a second latch 321, a timer 322, and a minimum off time control unit 323. A first input end of the AND gate 320 is electrically connected to the second end of the time expansion unit 33, a second input end of the AND gate 320 is electrically connected to the COT trigger signal generation module 20, an output end of the AND gate 320 is electrically connected to a first input end S of the second latch 321, an output end of the second latch 321 is electrically connected to an input end of the timer 322, an output end of the timer 322 is electrically connected to a first end of the minimum off time control unit 323, a second end of the minimum off time control unit 323 is electrically connected to a second end of the logic OR gate unit 34, and a third end of the minimum off time control unit 323 is electrically connected to a third input end of the AND gate 320.

The first control unit 31 is configured to generate the fixed on frequency pulse width signal fixed-frequency PWM based on the duty ratio modulation signal MAIN_TRIP and the clock signal CLK, and output the fixed on frequency pulse width signal frequency PWM to the time expansion unit 33 and the logic OR gate unit 34 respectively.

The time expansion unit 33 is configured to output a first control signal to the second control unit 32 based on the received fixed on frequency pulse width signal fixed-frequency PWM when the fixed on frequency pulse width signal fixed-frequency PWM is within a first preset time period, and output a second control signal to the second control unit 32 when the fixed on frequency pulse width signal fixed-frequency PWM is within a second preset time period, where the first preset time period includes a time period when the fixed on frequency pulse width signal fixed-frequency PWM is a high level signal plus a minimum off time of at least one COT pulse width signal COT PWM, and the second preset time period includes a time period when the fixed on frequency pulse width signal fixed-frequency PWM is a low level signal minus the minimum off time of the at least one COT pulse width signal COT PWM.

The second control unit 32 is configured to output the COT pulse width signal COT PWM to the logic OR gate unit 34 based on the COT trigger signal COT_TRIGGER when the second control signal and the COT trigger signal COT_TRIGGER are received.

The logic OR gate unit 34 is configured to generate a target pulse signal PWM based on the fixed on frequency pulse width signal fixed-frequency PWM and the COT pulse width signal COT PWM.

As shown in FIG. 2, the operation principle of the control module is as follows: when the second control unit 32 receives the first control signal output by the time expansion unit 33 and does not receive the COT trigger signal COT_TRIGGER output by the COT trigger signal generation module 20, the second control unit 32 does not output the COT pulse width signal COT PWM to the logic OR gate unit 34. At this time, the first control unit 31 generates the fixed on frequency pulse width signal fixed-frequency PWM based on the duty ratio modulation signal MAIN_TRIP and the clock signal CLK, and sends the generated fixed on frequency pulse width signal fixed-frequency PWM to the logic OR gate unit 34. Therefore, the logic OR gate unit 34 outputs the target pulse width signal based on the fixed on frequency pulse width signal fixed-frequency PWM, and controls the on and off of the upper power transistor MHI and the lower power transistor ML in the main power module 40 based on the target pulse width signal, and the main power module 40 operates in a fixed on frequency mode. When the second control unit 32 receives the second control signal output by the time expansion unit 33 and the COT trigger signal COT_TRIGGER output by the COT trigger signal generation module, the second control unit 32 outputs the COT pulse width signal COT PWM to the logic OR gate unit 34. At this time, the logic OR gate unit 34 outputs the fixed on frequency pulse width signal fixed-frequency PWM when the fixed on frequency pulse width signal is at the high level, and outputs the COT pulse width signal COT PWM when the fixed on frequency pulse width signal is at the low level. That is, the target pulse width signal at this time includes the fixed on frequency pulse width signal fixed-frequency PWM and the COT pulse width signal COT PWM, and the main power module 40 operates alternately in the fixed conduction frequency mode and the COT mode, where the second control unit 32 receives the COT trigger signal COT_TRIGGER indicating that the output voltage of the direct current output voltage node of the power system drops due to a load change, so that the ripple voltage of the COT trigger signal generation module is lower than the ripple reference voltage. At this time, the operating mode of the main power module is adjusted from a fixed-frequency mode to a variable-frequency mode (that is, the main power module 40 operates alternately in the fixed on frequency mode and the COT mode).

In the above embodiment, the time expansion unit 33 receives the fixed on frequency pulse width signal fixed-frequency PWM, and outputs the first control signal to the second control unit 32 when the fixed on frequency pulse width signal fixed-frequency PWM is within the first preset time period, and outputs the second control signal to the second control unit 32 when the fixed on frequency pulse width signal fixed-frequency PWM is within the second preset time period, that is, the first control signal is output in a time window in which the fixed on frequency pulse width signal takes effect (that is, the time period when the fixed on frequency pulse width signal is a high level signal plus the minimum off time of the at least one COT pulse width signal), and the second control signal is output outside the time window in which the fixed on frequency pulse width signal takes effect (that is, the time period when the fixed on frequency pulse width signal is a low level signal minus the minimum off time of the at least one COT pulse width signal), so that in addition to the fixed-frequency PWM operation, when the load increases, a transient enhancement circuit intervenes in the control and adjusts the operating mode of the main power module from the fixed-frequency mode to the variable-frequency mode (that is, the main power module 40 operates alternately in the fixed-frequency mode and the COT mode).

It is to be noted that, in the above embodiment, when the fixed-frequency mode is switched to the variable-frequency mode, in order to avoid directly outputting the high level signal after the switching, the time expansion unit is provided, and the time expansion unit expands the time period when the fixed on frequency pulse width signal is the high level signal by the minimum off time of the at least one COT pulse width signal COT PWM, that is, after the high level signal of the fixed on frequency pulse width signal ends, the minimum off time of the COT pulse width signal COT PWM is added, and then the variable-frequency mode is switched.

In addition, the above embodiment exemplarily indicates that the first preset time period includes the time period when the fixed on frequency pulse width signal fixed-frequency PWM is the high level signal plus the minimum off time of the COT pulse width signal COT PWM, and the second preset time period includes the time period when the fixed on frequency pulse width signal fixed-frequency PWM is the low level signal minus the minimum off time of the COT pulse width signal COT PWM. In a specific implementation, when the variable-frequency mode is switched to the fixed-frequency mode, in order to avoid switching to the fixed-frequency mode when the variable-frequency mode is the high level signal, the minimum off time of the COT pulse width signal COT PWM also needs to be expanded through the time expansion unit for the time window in which the fixed-frequency mode takes effect, that is, before the high level signal of the fixed on frequency pulse width signal starts, the minimum off time of the COT pulse width signal COT PWM is added.

In the above embodiment, the first control unit 31 includes the first latch 310 and the minimum on/off time control unit 311. A set end S (i.e., the first input end) of the first latch 310 receives the clock signal CLK output by the oscillator module, a reset end R (i.e., the second input end) of the first latch 310 receives the duty ratio modulation signal MAIN_TRIP output by the duty ratio modulation signal generation module 10, and the output end Q of the first latch 310 outputs the first output signal to the minimum on/off time control unit 311. The minimum on/off time control unit processes the first output signal and generates the fixed on frequency pulse width signal (i.e., the first output signal is processed to ensure that the time the pulse width signal is at the high level and the time the pulse width signal is at the low level meet the set time), and the fixed conduction frequency pulse width signal is output respectively and input to the logic OR gate unit 34 and the time expansion unit 33 respectively. When the logic OR gate unit 34 does not receive the COT pulse width signal output by the second control unit 32, at this time, the logic OR gate unit 34 outputs the target pulse width signal PWM to a drive circuit (not shown in the figure) based on the fixed on frequency pulse width signal, and the drive circuit generates a control signal based on the target pulse width signal to control ends of the upper power transistor ML and the lower power transistor MH to control the on and off of the upper power transistor MH and the lower power transistor MIL.

The second control unit 32 at least includes the AND gate 320, the second latch 321, the timer 322, and the minimum off time control unit 323. The first end of the AND gate 320 receives the first control signal (low level signal) or the second control signal (high level signal) output by the time expansion unit 33, and the second end of the AND gate 320 receives the COT trigger signal COT_TRIGGER (high level signal) output by the COT trigger signal generation module 20. When the first end of the AND gate 320 receives the second control signal (high level signal), and the AND gate 320 receives the COT trigger signal COT_TRIGGER (high level signal), the AND gate 320 outputs the high level signal to the set end S (first input end) of the second latch 321, the output end Q of the second latch 321 outputs the high level signal, and the timer 322 starts timing, so that the time the pulse width signal output by the timer is at the high level meets the set COT, and then the minimum off time control unit makes the time the output pulse width signal is at the low level meet the minimum off time, that is, the COT pulse width signal COT PWM is generated and sent to the logic OR gate unit 34. At this time, the logic OR gate unit 34 outputs the target pulse width signal PWM to the drive circuit (not shown in the figure) based on the fixed on frequency pulse width signal fixed-frequency PWM and the COT pulse width signal COT PWM, and the drive circuit generates the control signal to the control ends of the upper power transistor MH and the lower power transistor ML based on the target pulse width signal to control the on and off of the upper power transistor MH and the lower power transistor ML.

In addition, when the timer 322 starts timing, ONE SHOT receives the high level output from the output end Q of the second latch 321, and outputs a reset pulse to the reset end R of the second latch to reset a state of the second latch 321, so that the output end Q of the second latch 321 outputs the low level signal to the timer 322, and the timer continues timing without being affected by the output inversion of the output end Q of the second latch 321 until the next time the second latch 321 outputs the high level signal to trigger the timer 322 to start timing again, that is, when the input of the AND gate 320 is high again, the reset end S of the second latch receives the high level output by the AND gate 320 again, and the output end Q of the second latch 321 outputs the high level signal to the timer 322.

It is to be noted that, in the above embodiment, in the initial state, the third end of the AND gate 320 always receives the high level signal output by the minimum off time control unit 323. At this time, since the first end of the AND gate 320 does not receive the second control signal (high level signal) or the second end of the AND gate 320 does not receive the COT trigger signal COT_TRIGGER (high level signal), the AND gate 320 does not output the high level signal to the set end S of the second latch 321. When the first end of the AND gate 320 receives the second control signal (high level signal), and the second end of the AND gate 320 receives the COT trigger signal COT_TRIGGER (high level signal), the AND gate 320 outputs the high level signal to the set end S of the second latch 321, the output end Q of the second latch 321 outputs the high level signal, and the timer 322 starts timing, so that the time the pulse width signal output by the timer is at the high level meets the set COT, and then the minimum off time control unit makes the time the output pulse width signal is at the low level meet the minimum off time. In addition, the third end of the minimum off time control unit is provided to be electrically connected to the third input end of the AND gate, that is, when the time the output pulse width signal is at the low level does not meet the minimum off time, the low level signal is output to the AND gate, and when the time the output pulse width signal is at the low level meets the minimum off time, the high level signal is output to the AND gate, thereby ensuring that the time the output COT pulse width signal is at the low level meets the minimum on time.

The control circuit of the switching converter provided by the embodiment of the present disclosure combines the characteristics of a fixed-frequency system and a variable-frequency system. When the ripple voltage generated by the ripple voltage generation circuit based on the collected operating state of the main power module is higher than the ripple reference voltage, at this time, the control module generates the fixed on frequency pulse width signal based on the received duty ratio modulation signal and the clock signal, and outputs the control signal corresponding to the fixed on frequency pulse width signal, so that the main power module operates in the fixed on frequency mode. When the ripple voltage generated by the ripple voltage generation circuit based on the collected operating state of the main power module is lower than the ripple reference voltage, at this time, the control signal is generated based on the fixed frequency pulse signal, and then the COT pulse width signal is generated based on the control signal and the COT trigger signal. At this time, the main power module operates alternately in the fixed on frequency mode and the COT mode, so that the switching converter has a better transient response speed and a smaller output voltage change, and the stability of the system is ensured. In addition, the control circuit of the switching converter provided by the embodiment of the present disclosure accelerates the transient response of the power system when the load increases, that is, there is no need to wait for the error amplifier output change, and there is no need to wait for the next clock cycle. At the same time, it is still a real fixed-frequency system during steady-state operation.

In addition, it may be seen from FIG. 1 and FIG. 2 that by adding a variable-frequency transient enhancement circuit to the fixed-frequency system, where the fixed-frequency system may be a voltage mode, current mode, V2 control, V2C control or other fixed-frequency control systems, so that the switching converter is still a real fixed-frequency system during steady-state operation, and the original loop characteristics are not destroyed, and only participate in the regulation in the loading process.

In the above embodiment, as shown in FIG. 1, the duty ratio modulation signal generation module 10 at least includes an error amplifier 11 and a first comparator 12, and the COT trigger signal generation module 20 at least includes the ripple voltage generation circuit 21, a ripple reference voltage generation circuit 22, and a second comparator 23. The error amplifier 11 receives a direct current output feedback voltage VFB of the main power module 40, and outputs an error voltage Veaout to the first comparator 12 according to the direct current output feedback voltage VFB and a reference voltage Vref FB. The first comparator 12 outputs the duty ratio modulation signal MAIN_TRIP according to the error voltage Veaout and the reference voltage Vref. The second comparator 23 receives the ripple voltage Vripple output by the ripple voltage generation circuit 21 and the ripple reference voltage Vref_ripple output by the ripple reference voltage generation circuit 22, and outputs the COT trigger signal according to the ripple voltage Vripple and the ripple reference voltage Vref_ripple.

As an implementation, when the power system operates normally, the COT trigger signal generation module 20 does not output the COT trigger signal to the control module, and the control module 30 generates the fixed on frequency pulse width signal based on the duty ratio modulation signal MAIN_TRIP and the clock signal CLK, and controls the on and off of the upper power transistor MH and the lower power transistor ML of the main power module 40 based on the generated fixed on frequency pulse width signal. When the fixed on frequency pulse width signal is the high level signal, the control module 30 outputs the control signal to control the upper transistor MH to be turned on and the lower transistor ML to be turned off. When the fixed on frequency pulse width signal is the low level signal, the control module 30 outputs a drive control signal to control the upper transistor MH to be turned off and the lower transistor ML to be turned on.

When the load corresponding to the power system increases, the COT trigger signal generation module 20 outputs the COT trigger signal to the control module 30. At this time, the control module 30 controls the on and off of the upper power transistor MH and the lower power transistor ML of the main power module 40 based on the fixed on frequency pulse width signal in the time window in which the fixed on frequency pulse width signal takes effect, and controls the on and off of the upper power transistor MH and the lower power transistor ML of the main power module 40 based on the COT pulse width signal outside the time window in which the fixed on frequency pulse width signal takes effect. Specifically, in the time window in which the fixed on frequency pulse width signal takes effect, that is, when the fixed on frequency pulse width signal is the high level signal, the control module 30 outputs the drive control signal to control the upper transistor MH to be turned on and the lower transistor ML to be turned off, and outside the time window in which the fixed on frequency pulse width signal takes effect, that is, when the fixed on frequency pulse width signal is the low level signal, the control module 30 controls the on and off of the upper power transistor MH and the lower power transistor ML of the main power module 40 based on the COT pulse width signal. When the COT pulse width signal is the high level signal, the control module 30 outputs the drive control signal to control the upper transistor MH to be turned on and the lower transistor ML to be turned off. When the COT pulse width signal is the low level signal, the control module 30 outputs the drive control signal to control the upper transistor MH to be turned off and the lower transistor ML to be turned on.

It is to be noted that, in the embodiment, when the load corresponding to the power system increases, in the process of the COT trigger signal generation module 20 outputting the COT trigger signal to the control module 30, the COT pulse width signal is allowed to be triggered only after the previous fixed on frequency pulse width signal ends min off of the at least one COT pulse width signal, that is, outside the time window in which the fixed on frequency pulse width signal takes effect, so as to avoid directly outputting the high level signal when switching from the fixed on frequency mode to the COT mode, and to ensure that the fixed on frequency pulse width signal in each cycle is not interfered with by the COT pulse width signal.

In addition, a ratio of on time to min off time in the COT pulse width signal generated by the second control unit determines, to a certain extent, the maximum duty ratio (i.e., min off time) in the system response process when the load changes, and determines the speed at which the system can respond to the load change, where on time may be selected more freely within a time period less than the clock cycle, when on time is set to be shorter, the frequency conversion action may be more intense when the system load changes, and when on time is set to be longer, the frequency change is smaller when the system load changes, but there is a possibility of overshoot in the recovery process. A time ratio of on time to min off time is not specifically limited in the embodiments of the present disclosure.

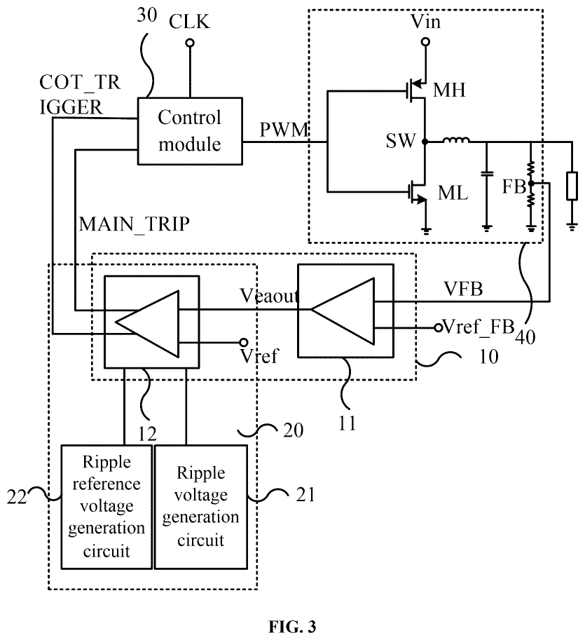

As a specific implementation, the COT trigger signal generation module 20 and the duty ratio modulation signal generation module 30 multiplex the same comparator, as shown in FIG. 3 (FIG. 3 exemplarily represents the multiplexing of the first comparator 12), a first input end of the comparator 12 is electrically connected to an output end of the error amplifier 11, a second input end of the comparator 12 is electrically connected to a reference voltage node Vref, a third input end of the comparator 12 is electrically connected to the ripple voltage generation circuit 21, a fourth input end of the comparator 12 is electrically connected to the ripple reference voltage generation circuit 22, a first output end of the comparator 12 is electrically connected to the first end of the control module 30, and a second output end of the comparator 12 is electrically connected to the second end of the control module 30.

The comparator outputs the duty ratio modulation signal MAIN_TRIP according to the error voltage Veaout and the reference voltage Vref, and outputs the COT trigger signal according to the ripple voltage Vripple and the ripple reference voltage Vref_ripple.

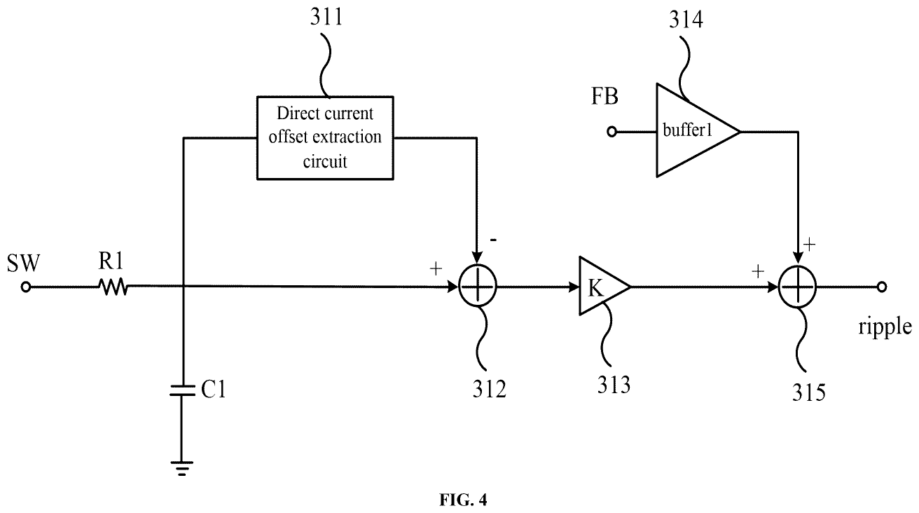

Based on the above embodiment, FIG. 4 is a schematic structural diagram of a ripple voltage generation circuit according to an embodiment of the present disclosure. As shown in FIG. 4, the ripple voltage generation circuit 31 includes a first resistor R1, a first capacitor C1, a direct current offset extraction circuit 311, a first adder 312, an amplifier 313, a first buffer 314, and a second adder 315. A first end of the first resistor R1 is electrically connected to a switch node SW, a second end of the first resistor R1 is electrically connected to a first end of the first adder 312, a first end of the direct current offset extraction circuit 311, and a first end of the first capacitor C1 respectively, a second end of the direct current offset extraction circuit 311 is electrically connected to a second end of the first adder 312, a third end of the first adder 312 is electrically connected to a first end of the amplifier 313, a second end of the amplifier 313 is electrically connected to a first end of the second adder 315, a first end of the first buffer 314 is electrically connected to the output voltage feedback node FB, a second end of the first buffer 314 is electrically connected to a second end of the second adder 315, an output end of the second adder 315 is electrically connected to a ripple voltage generation node ripple, and a second end of the first capacitor C1 is electrically connected to a ground node.

In conjunction with FIG. 4, the first resistor R1 and the first capacitor C1 form a filter circuit, which filters a sampling voltage corresponding to the switch node SW (collecting the voltage corresponding to the main power module) to obtain a filtered sampling voltage and then outputs the filtered sampling voltage to the direct current offset extraction circuit 311, the direct current offset extraction circuit 311 extracts a direct current signal in a signal of the switch node SW, the first adder removes the direct current signal in the signal of the switch node SW, and outputs an alternating current signal in the filtered signal of the switch node SW to the amplifier 313, the amplifier amplifies the alternating current signal in the filtered signal of the switch node SW to obtain an amplified alternating current signal and then adds the amplified alternating current signal to the direct current output voltage of the output voltage feedback node FB through the second adder 315 to obtain the ripple voltage.

In the embodiment, the first ripple voltage generated by the ripple circuit generation circuit 21 is the alternating current signal in the signal corresponding to the switch node SW output by the first adder 312, and the alternating current is related to the target pulse width signal output by the control module. In the implementation, the first ripple voltage may be the alternating current. The specific manner in which the first ripple voltage is related to the target pulse width signal output by the control module 30 includes that: the frequency of the first ripple voltage is the same as that of the target pulse width signal, and the duty ratio of the first ripple voltage is the same as that of the target pulse width signal.

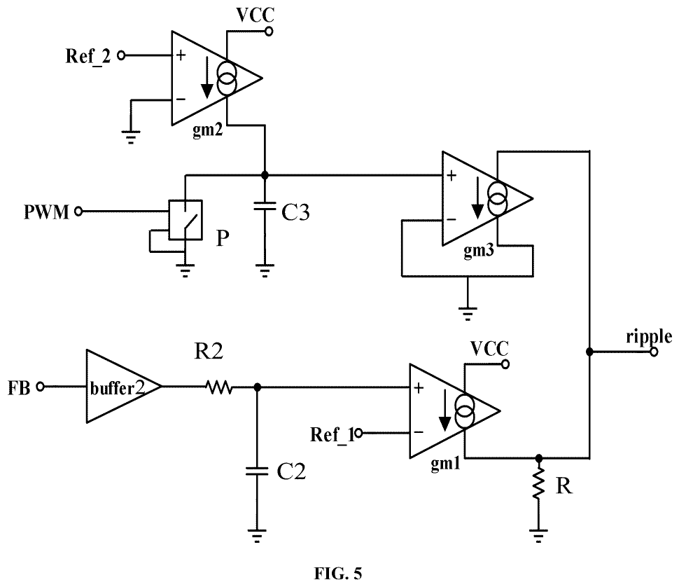

Based on the above embodiment, FIG. 5 is a schematic structural diagram of another ripple voltage generation circuit according to an embodiment of the present disclosure. As shown in FIG. 5, the ripple voltage generation circuit includes a second buffer buffer2, a second resistor R2, a second capacitor C2, a first transconductance amplifier gm1, a second transconductance amplifier gm2, a switch P, a third capacitor C3, and a third transconductance amplifier gm3. A first end of the second buffer buffer2 is electrically connected to the output voltage feedback node FB, a second end of the second buffer buffer2 is electrically connected to a first end of the second resistor R2, a second end of the second resistor R2 is electrically connected to a first end of the first transconductance amplifier gm1 and a first end of the second capacitor C2 respectively, a second end of the second capacitor C2 is electrically connected to the ground node, a second end of the first transconductance amplifier gm1 is electrically connected to a first reference voltage node Ref_1, a third end of the first transconductance amplifier gm1 and a fourth end of the third transconductance amplifier gm3 are electrically connected to the ripple voltage generation node ripple, a fourth end of the first transconductance amplifier gm1 is electrically connected to a power supply voltage node VCC, a first end of the second transconductance amplifier is electrically connected to a second reference voltage node Ref_2, a second end of the second transconductance amplifier gm2 is electrically connected to the ground node, a third end of the second transconductance amplifier gm2 is electrically connected to a first end of the third capacitor C3, a first end of the switch P, and a first end of the third transconductance amplifier gm3 respectively, a fourth end of the second transconductance amplifier gm2 is electrically connected to the power supply voltage node VCC, a second end of the third transconductance amplifier gm3 and a third end of the third transconductance amplifier gm3 are connected to the ground node, a second end and a third end of the switch are electrically connected to the ground node, a control end of the switch P is electrically connected to a pulse width signal output node PWM, and a second end of the third capacitor C3 is electrically connected to the ground node.

In conjunction with FIG. 5, the second resistor R2 and the second capacitor C2 form a filter circuit, which filters the sampling voltage corresponding to the output voltage feedback node FB to obtain a filtered sampling voltage and then outputs the filtered sampling voltage to the first transconductance amplifier gm1, and the first transconductance amplifier gm1 generates a ripple direct current voltage. The control end of the switch P is electrically connected to the pulse width signal output node PWM. When the switch P is in an off state based on the pulse width signal output by the pulse width signal output node, a current output by the third end of the second transconductance amplifier gm2 charges the third capacitor C3, and when the switch P is in an on state based on the pulse width signal output by the pulse width signal output node, the third capacitor C3 discharges, a triangular wave is formed based on the charging and discharging of the third capacitor C3 and input to the third transconductance amplifier gm3, a ripple current is generated based on the third transconductance amplifier gm3, and the ripple voltage Vripple is output based on a voltage generated by the ripple current and the resistor and the ripple direct current voltage.

In the above embodiment, FIG. 4 is a structure for generating the ripple voltage by superimposing a ripple signal on the output voltage feedback node FB, and the ripple signal is obtained by the switch node SW. FIG. 5 generates the ripple voltage in the form of a charge pump, where the second reference node Ref_2, the second transconductance amplifier gm2, and the third transconductance amplifier gm3 may be configured to change the ripple current, thereby controlling the transient response speed.

It is to be noted that the applicant has discovered through research that, compared with the ripple voltage generated by an Equivalent Series Resistance (ESR) of an output capacitor, the ripple voltage generated by the ripple voltage generation circuit provided by the embodiment of the present disclosure has a faster drop speed in the loading process, that is, since a portion of the charge may be extracted from the output capacitor in the load loading process, the response speed of the ripple voltage generation circuit in the present disclosure is slower and the output voltage drops more. Therefore, the ripple voltage generation circuit further includes a differentiator. By arranging the differentiator, the differentiator performs differentiation processing on the direct current output feedback voltage VFB and then adds same to the ripple voltage to ensure the speed of generating the ripple voltage.

In addition, in the embodiment, the first ripple voltage generated by the ripple circuit generation circuit 21 is a triangular wave output by the third end of gm2. The specific manner in which the first ripple voltage generated by the ripple voltage generation circuit 21 is related to the target pulse width signal output by the control module 30 includes that: the frequency of the first ripple voltage is the same as that of the target pulse width signal, and the duty ratio of the first ripple voltage is a duty ratio of the 1-target pulse width signal.

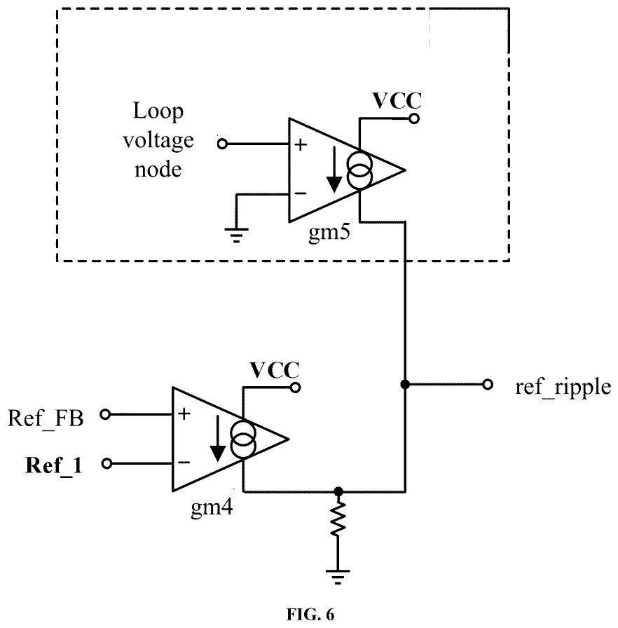

Based on the above embodiment, FIG. 6 is a structural schematic diagram of a ripple reference voltage generation circuit according to an embodiment of the present disclosure. As shown in FIG. 6, the ripple reference voltage generation circuit includes a fourth transconductance amplifier gm4 and a fifth transconductance amplifier gm5. A first end of the fourth transconductance amplifier gm4 is electrically connected to a reference voltage node Ref_FB of an output feedback voltage, a second end of the fourth transconductance amplifier gm4 is electrically connected to the first reference voltage node Ref_1, a third end of the fourth transconductance amplifier gm4 and a third end of the fifth transconductance amplifier gm5 are electrically connected to a ripple reference voltage node ref_ripple, a first end of the fifth transconductance amplifier gm5 is electrically connected to a loop voltage node, a second end of the fifth transconductance amplifier gm5 is electrically connected to the ground node, and a fourth end of the fourth transconductance amplifier gm4 and a fourth end of the fifth transconductance amplifier gm5 are electrically connected to the power supply voltage node VCC respectively.

By electrically connecting the first end of the fourth transconductance amplifier gm4 to the reference voltage node Ref_FB of the output feedback voltage (an output reference voltage outputted by the reference voltage node Ref_FB of the output feedback voltage), the fourth transconductance amplifier generates the ripple reference voltage based on the output reference voltage output by the reference voltage node of the output feedback voltage. In addition, by arranging the fifth transconductance amplifier gm5, the transient enhancement characteristic may better cover the application scenarios with high and low duty ratios.

In the above embodiment, the loop voltage node is the output node of a voltage processing module. The voltage processing module receives a direct current input voltage and the direct current output voltage, and outputs a voltage signal associated with the direct current input voltage and the direct current output voltage after processing the direct current input voltage and the direct current output voltage.

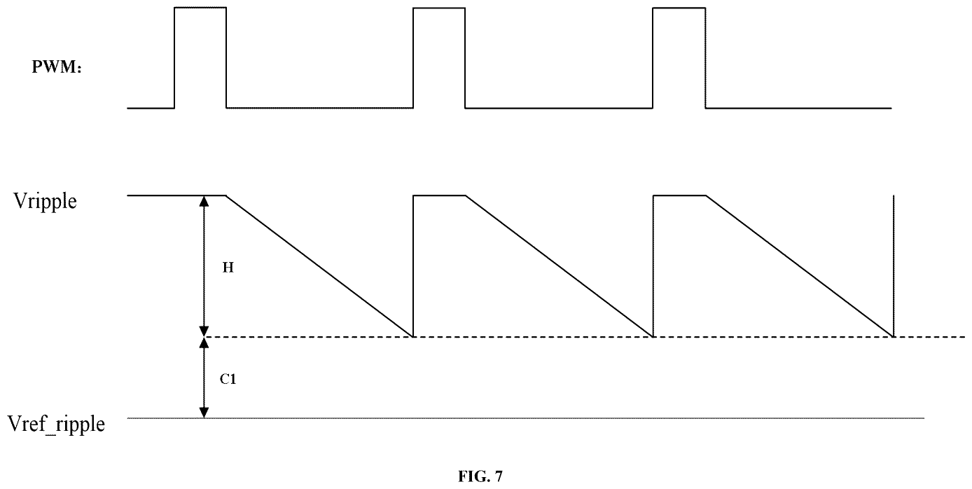

In a specific implementation, in conjunction with FIG. 7, PWM represents the pulse width signal input to the control end of the switch P, Vripple represents the ripple voltage generated by the ripple voltage generation circuit shown in FIG. 5, Vref_ripple represents the ripple reference voltage generated by the ripple voltage generation circuit shown in FIG. 6, and the amplitude H of the ripple voltage may be expressed as:

$$H = k \times ( 1 - D ) T$$

Where k is a ripple voltage slope, D is a duty ratio, and T is a period.

From FIG. 5, it may be deduced that the ripple voltage slope satisfies:

$$k = \frac{Ref\_ 2 \times gm 2}{C 3} \times gm 3 \times R$$

Therefore, the amplitude H of the ripple voltage may be expressed as:

$$H = \frac{Ref\_ 2 \times gm 2}{C 3} \times gm 3 \times R \times \frac{{V}_{in} - {V}_{out}}{{V}_{in}} \times T$$

From FIG. 6, it may be deduced that the ripple reference voltage and the ripple voltage satisfy the relationship:

That is:

$$gm 5 \times R \times {V}_{in \_ gm 5} = - \frac{Ref\_ 2 \times gm 2}{C 3} \times gm 3 \times R \times \frac{{V}_{in} - {V}_{out}}{{V}_{in}} \times T - {C}_{1}$$

$${V}_{in \_ gm 5} = - \frac{Ref\_ 2 \times gm 2}{C 3} \times \frac{gm 3}{gm 5} \times \frac{{V}_{in} - {V}_{out}}{{V}_{in}} \times T - {C}_{2}$$

Where C1 and C2 are constants

$${C}_{2} = \frac{{C}_{1}}{gm 5 \times R} .$$

That is, the voltage signal output by the loop voltage node satisfies

$${V}_{in \_ gm 5} = - \frac{Ref\_ 2 \times gm 2}{C 3} \times \frac{gm 3}{gm 5} \times \frac{{V}_{in} - {V}_{out}}{{V}_{in}} \times T - {C}_{2} ,$$

that is, it is related to the direct current input voltage and the direct current output voltage.

It is to be noted that the circuit in the dotted box in FIG. 6 is an optional circuit, that is, the ripple reference voltage generation circuit may or may not include the circuit diagram in the dotted box. In a specific implementation, the ripple reference voltage may be generated by the output reference voltage, that is, the ripple reference voltage may be generated by the circuit excluding the dotted part shown in FIG. 6, or may be generated by the circuit including the dotted part shown in FIG. 6, which is not specifically limited in the embodiments of the present disclosure. When the ripple reference voltage is generated based on the ripple reference voltage generation circuit shown in FIG. 6, the ripple reference voltage is associated with the direct current input voltage and the direct current output voltage, and the transient enhancement characteristics may better cover application scenarios with high and low duty ratios.

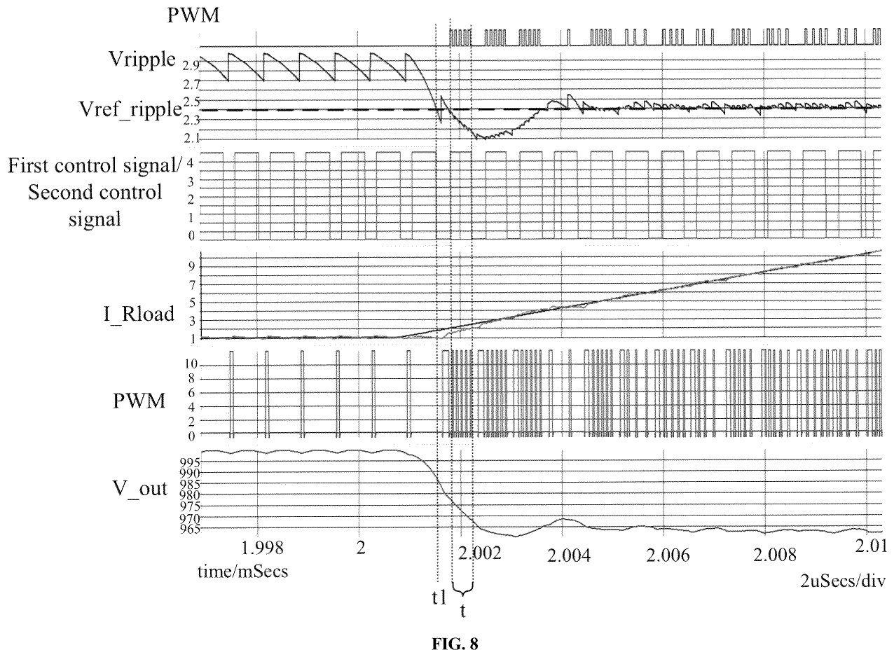

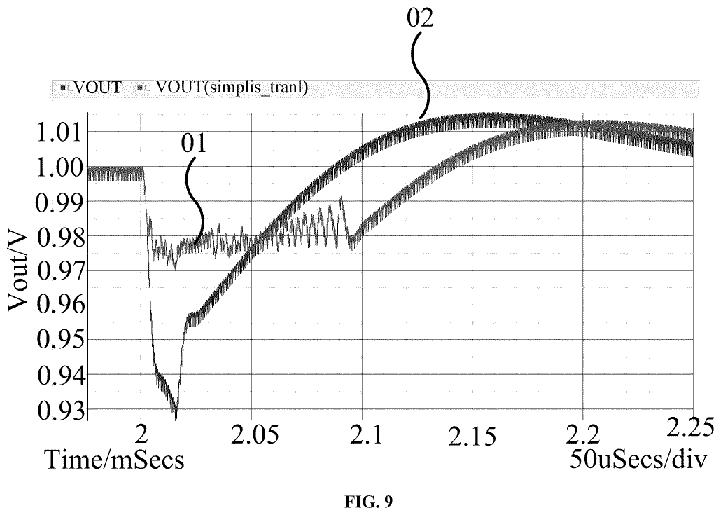

The following will be illustrated by a specific embodiment. Under the conditions that the input voltage Vin is equal to 12 V, the output voltage Vout is equal to 1 V, the load step takes 15 μs at 1 A to 16 A, the output capacitor C is equal to 100 uF, and inductor L is equal to 220 nH, an operation time sequence diagram of a control circuit of a switching converter is as shown in FIG. 8, and a schematic diagram of simulation results of an output voltage of a switching converter with a variable-frequency transient enhancement circuit added and the output voltage of the switching converter without the variable-frequency transient enhancement circuit added is as shown in FIG. 9.

In FIG. 9, waveform 01 is a schematic diagram of the simulation result of the output voltage of the switching converter with the variable-frequency transient enhancement circuit added, and waveform 02 is a schematic diagram of the simulation result of the output voltage of the switching converter without the variable-frequency transient enhancement circuit added. In conjunction with FIG. 8 and FIG. 9, before time t1, the ripple voltage Vripple is greater than the ripple reference voltage Vref_ripple, and the switching converter operates in the fixed on frequency mode. After time t1, the ripple voltage Vripple is less than the ripple reference voltage Vref_ripple, and the COT trigger signal generation module outputs the COT trigger signal to the control module. At this time, the switching converter operates in the COT mode within the off time of the fixed on frequency pulse width signal (that is, outside the time window in which the fixed on frequency pulse width signal takes effect, the high level interval in FIG. 8, that is, within the t time period). It may be seen from FIG. 8 and FIG. 9 that under the same conditions, the switching converter is added with the variable-frequency transient enhancement circuit, the system undergoes frequency conversion action in the loading process, and the total time the power transistor is turned on within a fixed-frequency period is significantly lengthened, Vout is decreased by 30 mV, the drop is reduced by 58.5%, and a Vout drop value is greatly reduced.

According to the control circuit of the switching converter provided by the embodiment of the present disclosure, when the power system operates normally, the ripple voltage Vripple is always higher than the ripple reference voltage Vref_ripple, the COT trigger signal generation module does not trigger the generation of the COT trigger signal, and the control circuit of the switching converter operates in the original fixed on frequency mode.

When the load of the power system increases, the output voltage of the main power module drops. If the ripple voltage Vripple is lower than the ripple reference voltage Vref_ripple outside the time window in which the fixed-frequency PWM takes effect, the COT trigger signal generation module triggers the generation of the COT trigger signal, and the control circuit of the switching converter switches from the original fixed on frequency mode to alternating operation of the fixed on frequency mode and the COT mode, that is, the transient enhancement circuit intervenes in the control, the power system increases the frequency in response to the load change until the ripple voltage Vripple is higher than the ripple reference voltage Vref_ripple, and the control circuit of the switching converter switches to the fixed on frequency mode.

Based on the above embodiment, the embodiments of the present disclosure further provide a variable-frequency switching converter, including the control circuit of the variable-frequency switching converter of any one of the above embodiments, having the beneficial effects of any one of the above embodiments, which will not be illustrated one by one in the embodiments of the present disclosure.

Unless otherwise indicated clearly in the context, the singular form of terms used herein and in the appended claims includes the plural, and vice versa. Therefore, when referring to the singular, it usually includes the plural of the corresponding term. Similarly, the words “include” and “comprise” will be interpreted as inclusive rather than exclusive. Similarly, the terms “include” and “or” shall be interpreted as including, unless such interpretation is expressly prohibited herein. Where the term “example” is used herein, particularly when it is behind a group of terms, the “example” is only exemplary and illustrative, and should not be considered exclusive or extensive.

Further aspects and scope of adaptability become apparent from the description provided herein. It is to be understood that various aspects of the present disclosure may be implemented separately or in combination with one or more other aspects. It is also to be understood that the description and specific embodiments herein are for illustrative purposes only and are not intended to limit the scope of the present disclosure.

Several embodiments of the present disclosure have been described in detail above. However, apparently, those skilled in the art can make various modifications and variants to the embodiments of the present disclosure without departing from the spirit and scope of the present disclosure. The scope of the present disclosure is limited by the appended claims.

What is claimed is:

1. A control circuit of a variable-frequency switching converter, comprising a duty ratio modulation signal generation module, a Constant On Time (COT) trigger signal generation module, and a control module;
wherein the duty ratio modulation signal generation module is configured to output a duty ratio modulation signal to a first end of the control module;
the COT trigger signal generation module is configured to output a COT trigger signal to a second end of the control module when a ripple voltage is less than a ripple reference voltage;
the control module is configured to generate a fixed on frequency pulse width signal based on the duty ratio modulation signal and a clock signal when the COT trigger signal is not received, generate a control signal based on the fixed on frequency pulse width signal, generate a COT pulse width signal based on the control signal and the COT trigger signal when the COT trigger signal is received, and generate a target pulse width signal based on the fixed on frequency pulse width signal and the COT pulse width signal;
wherein the ripple voltage is generated based on a ripple voltage generation circuit, the ripple voltage generation circuit is configured to generate a first ripple voltage, and superpose a feedback voltage on an output voltage feedback node and the first ripple voltage to generate the ripple voltage, and the first ripple voltage is related to the target pulse width signal output by the control module.

2. The control circuit according to claim 1, wherein the control module comprises a first control unit, a second control unit, a time expansion unit, and a logic OR gate unit;
the first control unit is configured to generate the fixed on frequency pulse width signal based on the duty ratio modulation signal and the clock signal, and output the fixed on frequency pulse width signal to the time expansion unit and the logic OR gate unit respectively;
the time expansion unit is configured to output a first control signal to the second control unit based on the fixed on frequency pulse width signal when the fixed on frequency pulse width signal is within a first preset time period, and output a second control signal to the second control unit based on the fixed on frequency pulse width signal when the fixed on frequency pulse width signal is within a second preset time period, wherein the first preset time period comprises a time period when the fixed on frequency pulse width signal is a high level signal plus a minimum off time of at least one COT pulse width signal; the second preset time period comprises a time period when the fixed on frequency pulse width signal is a low level signal minus the minimum off time of the at least one COT pulse width signal;
the second control unit is configured to output the COT pulse width signal to the logic OR gate unit based on the COT trigger signal when the second control signal and the COT trigger signal are received; and
the logic OR gate unit is configured to generate a target pulse signal based on the fixed on frequency pulse width signal and the COT pulse width signal.

3. The control circuit according to claim 2, wherein,
when the second control unit receives the first control signal output by the time expansion unit and does not receive the COT trigger signal output by the COT trigger signal generation module, the second control unit does not output the COT pulse width signal to the logic OR gate unit, the first control unit generates the fixed on frequency pulse width signal based on the duty ratio modulation signal and the clock signal, and sends the fixed on frequency pulse width signal to the logic OR gate unit, and the logic OR gate unit outputs the target pulse width signal based on the fixed on frequency pulse width signal; and
when the second control unit receives the second control signal output by the time expansion unit and the COT trigger signal output by the COT trigger signal generation module, the second control unit outputs the COT pulse width signal to the logic OR gate unit, the logic OR gate unit outputs the fixed on frequency pulse width signal when the fixed on frequency pulse width signal is at a high level, and the logic OR gate unit outputs the COT pulse width signal when the fixed on frequency pulse width signal is at a low level.

4. The control circuit according to claim 2, wherein a first end of the first control unit is electrically connected to an oscillator module, a second end of the first control unit is electrically connected to the duty ratio modulation signal generation module, a third end of the first control unit is electrically connected to a first end of the time expansion unit and a first end of the logic OR gate unit respectively, a second end of the time expansion unit is electrically connected to a first end of the second control unit, a second end of the second control unit is electrically connected to the COT trigger signal generation module, and a third end of the second control unit is electrically connected to a second end of the logic OR gate.

5. The control circuit according to claim 4, wherein the first control unit comprises a first latch and a minimum on/off time control unit, wherein a first input end of the first latch is electrically connected to the oscillator module, a second input end of the first latch is electrically connected to the duty ratio modulation signal generation module, an output end of the first latch is electrically connected to a first end of the minimum on/off time control unit, and a second end of the minimum on/off time control unit is electrically connected to the first end of the time expansion unit and the first end of the logic OR gate unit respectively; and
the second control unit comprises an AND gate, a second latch, a timer, and a minimum off time control unit, wherein a first input end of the AND gate is electrically connected to the second end of the time expansion unit, a second input end of the AND gate is electrically connected to the COT trigger signal generation module, an output end of the AND gate is electrically connected to an input end of the second latch, an output end of the second latch is electrically connected to an input end of the timer, an output end of the timer is electrically connected to a first end of the minimum off time control unit, a second end of the minimum off time control unit is electrically connected to a second end of the logic OR gate unit, and a third end of the minimum off time control unit is electrically connected to a third input end of the AND gate.

6. The control circuit according to claim 1, wherein the duty ratio modulation signal generation module comprises an error amplifier and a first comparator, and the COT trigger signal generation module comprises a ripple voltage generation circuit, a ripple reference voltage generation circuit, and a second comparator;
the error amplifier receives a direct current output feedback voltage of a main power module, and outputs an error voltage to the first comparator according to the direct current output feedback voltage and a reference voltage;
the first comparator outputs the duty ratio modulation signal according to the error voltage and the reference voltage, wherein the duty ratio modulation signal generation module, the COT trigger signal generation module, the control module, and the main power module form a loop, and the reference voltage is generated by collecting information of the loop in real time; and
the second comparator receives the ripple voltage output by the ripple voltage generation circuit and the ripple reference voltage output by the ripple reference voltage generation circuit, and outputs the COT trigger signal according to the ripple voltage and the ripple reference voltage.

7. The control circuit according to claim 6, wherein the COT trigger signal generation module and the duty ratio modulation signal generation module multiplex a same comparator;
a first input end of the comparator is electrically connected to an output end of the error amplifier, a second input end of the comparator is electrically connected to a reference voltage node, a third input end of the comparator is electrically connected to the ripple voltage generation circuit, a fourth input end of the comparator is electrically connected to the ripple reference voltage generation circuit, a first output end of the comparator is electrically connected to the first end of the control module, and a second output end of the comparator is electrically connected to the second end of the control module; and
the comparator outputs the duty ratio modulation signal according to the error voltage and the reference voltage, and outputs the COT trigger signal according to the ripple voltage and the ripple reference voltage.

8. The control circuit according to claim 6, wherein the ripple voltage generation circuit comprises a first resistor, a first capacitor, a direct current offset extraction circuit, a first adder, an amplifier, a first buffer, and a second adder;
a first end of the first resistor is electrically connected to a switch node, a second end of the first resistor is electrically connected to a first end of the first adder, a first end of the direct current offset extraction circuit and a first end of the first capacitor respectively, a second end of the direct current offset extraction circuit is electrically connected to a second end of the first adder, a third end of the first adder is electrically connected to a first end of the amplifier, a second end of the amplifier is electrically connected to a first end of the second adder, a first end of the first buffer is electrically connected to the output voltage feedback node, a second end of the first buffer is electrically connected to a second end of the second adder, an output end of the second adder is electrically connected to a ripple voltage generation node, and a second end of the first capacitor is electrically connected to a ground node.

9. The control circuit according to claim 8, wherein the first resistor and the first capacitor filter a sampling voltage corresponding to the switch node to obtain a filtered sampling voltage and then output the filtered sampling voltage to the direct current offset extraction circuit, the direct current offset extraction circuit extracts a direct current signal in the filtered sampling voltage of the switch node, the first adder removes the direct current signal in the filtered sampling voltage of the switch node and outputs an alternating current signal in the filtered sampling voltage of the switch node to the amplifier, and the amplifier amplifies the alternating current signal in the filtered sampling voltage of the switch node to obtain an amplified alternating current signal and then adds the amplified alternating current signal to a direct current output voltage of the output voltage feedback node through the second adder to obtain the ripple voltage.

10. The control circuit according to claim 6, wherein the ripple voltage generation circuit comprises a second buffer, a second resistor, a second capacitor, a first transconductance amplifier, a second transconductance amplifier, a switch, a third capacitor, and a third transconductance amplifier;
a first end of the second buffer is electrically connected to the output voltage feedback node, a second end of the second buffer is electrically connected to a first end of the second resistor, a second end of the second resistor is electrically connected to a first end of the first transconductance amplifier and a first end of the second capacitor respectively, a second end of the second capacitor is electrically connected to a ground node, a second end of the first transconductance amplifier is electrically connected to a first reference voltage node, a third end of the first transconductance amplifier and a fourth end of the third transconductance amplifier are electrically connected to a ripple voltage generation node, a fourth end of the first transconductance amplifier is electrically connected to a power supply voltage node, a first end of the second transconductance amplifier is electrically connected to a second reference voltage node, a second end of the second transconductance amplifier is electrically connected to the ground node, a third end of the second transconductance amplifier is electrically connected to a first end of the third capacitor, a first end of the switch and a first end of the third transconductance amplifier respectively, a fourth end of the second transconductance amplifier is electrically connected to the power supply voltage node, a second end of the third transconductance amplifier and a third end of the third transconductance amplifier are connected to the ground node, a second end and a third end of the switch are electrically connected to the ground node, a control end of the switch is electrically connected to a pulse width signal output node, and a second end of the third capacitor is electrically connected to the ground node.

11. The control circuit according to claim 10, wherein the second resistor and the second capacitor filter a sampling voltage corresponding to the output voltage feedback node to obtain a filtered sampling voltage and then output the filtered sampling voltage to the first transconductance amplifier, and the first transconductance amplifier generates a ripple direct current voltage; and when the switch is in an off state based on a pulse width signal output by the pulse width signal output node, a current output by the third end of the second transconductance amplifier charges the third capacitor, and when the switch is in an on state based on the pulse width signal output by the pulse width signal output node, the third capacitor discharges, a triangular wave is formed based on charging and discharging of the third capacitor and input to the third transconductance amplifier, a ripple current is generated based on the third transconductance amplifier, and a ripple voltage is generated based on a voltage generated by the ripple current and the ripple direct current voltage.

12. The control circuit according to claim 6, wherein the ripple reference voltage generation circuit comprises a fourth transconductance amplifier and a fifth transconductance amplifier;
a first end of the fourth transconductance amplifier is electrically connected to a reference voltage node of an output feedback voltage, a second end of the fourth transconductance amplifier is electrically connected to a first reference voltage node, a third end of the fourth transconductance amplifier and a third end of the fifth transconductance amplifier are electrically connected to a ripple reference voltage node, a first end of the fifth transconductance amplifier is electrically connected to a loop voltage node, a second end of the fifth transconductance amplifier is electrically connected to a ground node, and a fourth end of the fourth transconductance amplifier and a fourth end of the fifth transconductance amplifier are electrically connected to a power supply voltage node respectively.

13. A variable-frequency switching converter, comprising the control circuit according to claim 1.
